(19) United States
(12) Patent Application Publication
(10) Pub. No.: US 2022/0329138 A1
(43) Pub. Date: Oct. 13, 2022

(54) INDUCTION GENERATOR

(71) Applicant: Nathaniel Brandon Haines, Englewod, FL (US)

(72) Inventor: Nathaniel Brandon Haines, Englewod, FL (US)

(21) Appl. No.: 17/224,727

(22) Filed: Apr. 7, 2021

(51) Int. Cl. H02K 31/02

(52) U.S. Cl. CPC H02K 31/02

(57) ABSTRACT

An induction generator having alternating layers of: (a) at least one rotating magnetic disk assembly with at least one magnet in each such disk; and (b) at least one stationary induction disk (a/k/a conductor disk assembly) with at least one conductive loop (i.e., at least one conductor) in each such conductor disk assembly. In one embodiment, the conductor has the shape of a compressed helicoid.

### BACKGROUND OF THE INVENTION

A “generator” is an electromechanical device that converts motive power (i.e., mechanical energy) into electrical power (i.e., electrical energy). Generators accomplish this conversion by applying the principles of Faraday's law of induction. More specifically, generators generate an electric current, by either:
(i) rotating a conductive coil with respect to a stationary magnetic field; or
(ii) rotating a magnetic field with respect to a stationary conductive coil.

In most traditional generators, the second of these two approaches is used, i.e., a rotating magnetic field is applied to a stationary conductive coil.

### A. Alternative Current Generators

In an Alternative current (“AC”) generator, the electric current is commonly drawn from the conductive coil using slip rings—resulting in a sinusoidal electrical output. Such traditional AC generators have two primary components, namely: (a) a rotor having at least one rotor coil; and (b) an armature (sometimes called stator) having at least one armature coil. The rotor produces a rotating magnetic flux while the armature remains stationary. This rotating magnetic flux induces AC electricity in the armature coils.

The rotor of an AC generator creates this rotating magnetic flux when:
(i) a direct current (“DC”) power source is used to excite the rotor coils—creating a magnetic field perpendicular to the plain of the rotor coils under ∅rsted's law; and
(ii) physically rotating the rotor using an external mechanical power source called a “prime mover” (e.g., a steam turbine or a combustion engine).

As the rotor coils are rotated by the prime mover about an axis (i.e., the axis of the prime mover), the magnetic field similarly rotates at the same speed. This revolving magnetic field, in turn, intersects armature coils which are fitted around the rotor. This generates an alternating electro-magnetic field across the stator windings which, under Faraday's law, induces an electric current in the armature coils. The amplitude and direction of this current varies in a sinusoidal way over time as the rotating electric field of the rotor passes through the armature loop. In order to generate three-phase AC current, three armatures—each spaced 120 degrees apart from one another—can be used. Generally, one end of these three armature coils are star-connected and three phase AC current is drawn from the other ends.

The relationship between the AC output frequency of an induction generator (in Hz),f, the number of rotor poles, P, and the rotational speed of the rotor (in rpm), N, is governed by the synchronous speed equation, to wit:

$$f = \frac{P N}{120}$$

Thus, for example, a four pole rotor generating AC output at 60 Hz:

$$f = \frac{P N}{120} \\ 60 = \frac{4 N}{120} \\ N = 1800 rpm$$

However, such high rotational speeds can be both difficult to generate using a prime mover. Such high rotational speeds also result in relatively high centripetal forces on the rotor and the rotor coils—potentially resulting in component damage. To overcome this, additional poles can be added. For example, some modern salient pole rotors have upwards of 20 poles, thus lowering the required rotational speed of the rotor, N.

AC motors further make use of pole cores to more effectively transfer magnetic flux. The rotor coils are then wound around these pole cores at the time of manufacture. Pole cores are often made of fairly thick insulated steel lamina. By using a core made of a material with a high magnetic permeability (such as a steel core), the strength of the induced magnetic field between the rotor and the armature can be confined and guided—resulting in more concentrated magnetic fields lines. This can result in a magnetic field several hundred times stronger as compared to not have a core. Such a core helps confine and guide the rotor's magnetic field. However, the use of a solid core can cause “core losses,” i.e., power loses as a result of eddy currents induced within the core. This has the added negative effect of creating induction heating—increasing the temperature of the coil/core assembly. To overcome this, modern AC generators do not use a solid steel core; rather, they use a laminated core. Laminated cores are comprised of numerous thin sheets of steel which have been coated with insulating material to increase electrical resistance between laminations: thereby reducing eddy currents and, thus, reducing “core losses.” Laminated cores also often use electrical steel, i.e., steel impregnated with silicon to increase electrical resistivity as compared to pure iron—further reducing eddy currents and, thus, further reducing “core losses.” Similarly, a stator core is used to enhance magnetic flux transfer—with the stator core similarly constructed of insulated steel lamina.

DC power is supplied to the rotor coils via slip rings. DC power is either supplied from an external DC power source or from a small DC generator fitted on the same prime mover (in the latter case, such generators are called “self-excited generators”).

### B. Direct Current Generators

In a DC generator, the electric current is commonly drawn from the conductive coil using a commutator and brush arrangement. In this case, the electricity produced in the conductive coil gets rectified through the commutator. Alternatively, DC power can be generated by passing AC power through a rectifier.

### C. Using Disk-Shaped Elements

Various attempts at improving traditional generators have made use of disk-shaped elements. One such attempt is disclosed in U.S. Pat. No. 5,606,210 (Lin) which teaches a generator having spinning magnetic disks with fixed disks made of nonmetallic material.

Another such attempt is disclosed in U.S. Pat. No. 6,040,650 (Rao) which teaches a stator having permanent magnets having metal foils with a supporting film.

Another such attempt is disclosed in European Patent Application No. EP1436883A2 (Eef Peters) which teaches a permanent magnet electrical generator/motor, a plurality of permanent magnets and stators having magnetic cores with distribution plates between the rotors and stators.

Another such attempt is disclosed in U.S. Pat. No. 6,515,391 (Whitesell) which teaches a generator with counter-rotating collectors in a radial magnetic field with stationary electrical connections.

Another such attempt is disclosed in U.S. Pat. No. 6,946,767 (Reardon) which teaches a generator having a series of rotating magnets and stationary coil elements.

Finally, another such attempt is disclosed in published U.S. patent application Ser. No. 10/911,867 (Obidniak) which teaches a generator having a series of alternative magnetic disks with stators made of nonmetallic material.

### SUMMARY OF THE INVENTION

The primary object of the present invention is directed to an induction generator having alternating: (a) rotating magnetic disks; and (b) stationary induction disks (a/k/a conducting disks).

An additional object of the present invention is directed to an AC indication generator by drawing the current off of a pair of positive and negative conductor busses.

An additional object of the present invention is directed to a DC indication generator by drawing the current off of a pair of positive and negative conductor busses in series with a rectifier or other similar device.

The present invention fulfills the above and other objects by providing a generator having several major components, namely: (i) at least one magnet disk assembly; (ii) at least one conductor disk assembly; and (iii) a drive shaft (on which the magnet disk assembly is mounted). In the preferred embodiment, an outer housing encloses the magnet disk assembly(ies) and the conductor disk assembly(ies), with the conductor disk assemblies mounted to the housing by housing mounts.

As a torque is applied to the drive shaft (by a prime mover such as a steam turbine, water turbine, internal combustion engine, etc.), the drive shaft is rotated; causing each magnet disk assembly to rotate. As noted above, this is one of the two ways to create a rotating magnetic flux with respect to a conducting loop (the other way being to rotate the conducting loop). As the magnet disk assembly rotates, the corresponding magnetic field rotates with respect to each stationary conductor disk assembly (and, thus, to each stationary conducting loop (called simply a “Conductor” herein). This rotating magnetic field variously intersects the conductors such that, under Faraday's law, an electric current is induced in the conductors—creating the basis for a new type of generator.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1A is a top view of a magnet disk assembly.

FIG. 1B is a side perspective view of a magnet disk assembly.

FIG. 1C is a top view of a conductor disk assembly.

FIG. 1D is a side perspective view of a conductor disk assembly.

FIG. 2 is a cutaway view of a generator comprising a plurality of magnet disk assemblies and conductor disk assemblies.

FIG. 3A is a side perspective view of a drive shaft with several disk assemblies in a first position.

FIG. 3B is a side perspective view of a drive shaft with several disk assemblies in a second position.

FIG. 4A is side perspective view of a conductor disk assembly having a line A̅B̅.

FIG. 4B is a cross-sectional view of a conductor disk assembly along a plane defined parallel to the conductor disk assembly along line A̅B̅ shown in FIG. 4A.

FIG. 4C is an exploded view of a helical conductor segment.

FIG. 5 is a cutaway view of a generator comprising a plurality of magnet disk assemblies and conductor disk assemblies.

FIG. 6A is a top view of an alternative embodiment of a magnet disk assembly.

FIG. 6B is a side perspective view of an alternative embodiment of a magnet disk assembly.

FIG. 6C is an exploded view of a circular sector-shaped conductor segment.

FIG. 7 is a perspective view of a conductor disk assembly showing the wiring diagram for a two pole system.

### REFERENCE NUMERAL CHART

For purposes of describing the preferred embodiment, the terminology used in reference to the number components in the drawings is as follows:

| 101a | Magnet Disk Assembly |
|---|---|
| 101b | Conductor Disk Assembly |
| 103 | Disk Body |
| 105a | Magnet |
| 105b | Conductor |
| 107a | Magnet Shaft Hole |
| 107b | Conductor Shaft Hole |
| 109 | Drive Shaft |
| 111 | Housing |
| 113 | Housing Mounts |
| 115 | Housing Overhang |
| 117 | Helical Conductor Segment |
| 119 | Positive Conductor Terminal |
| 121 | Negative Conductor Terminal |
| 123 | Insulating Coating |
| 125 | Positive Conductor Bus |
| 127 | Negative Conductor Bus |
| 129 | Positive Electromagnet Terminal |
| 131 | Negative Electromagnet Terminal |
| 133 | Positive Shaft Bus |
| 135 | Negative Shaft Bus |
| 137 | Output One |
| 139 | Output Two |

### DETAILED DESCRIPTION OF THE INVENTION

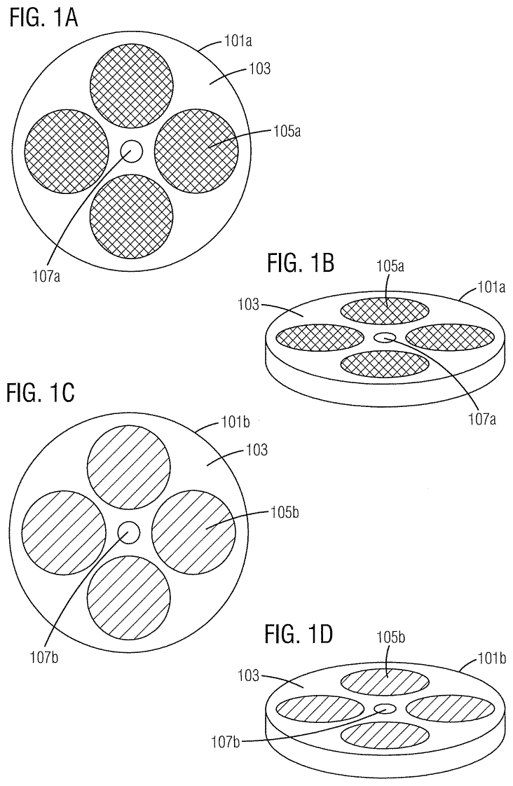

FIG. 1A is a top view of a Magnet Disk Assembly 101a having a Disk Body 103 and at least one Magnet 105a. The at least one Magnet 105a can be either a permanent magnet or an electromagnet. In the embodiment shown in FIG. 1A, each Magnet Disk Assembly 101a has four magnets. In another embodiment, the at least one Magnet 105a is formed by suspending magnetic or ferromagnetic particles in the Disk Body 103 itself. The Magnet Disk Assembly 101a further has a central Magnet Shaft Hole 107a. A side view of the Magnet Disk Assembly 101a is shown in FIG. 1B wherein can be seen the same Disk Body 103, at least one Magnet 105a and Magnet Shaft Hole 107a.

FIG. 1C is a top view of a Conductor Disk Assembly 101b having a Disk Body 103 and at least one Conductor 105b. Each Conductor 105b is independently connected to wires (not shown in FIG. 1C or FIG. 1D). In the embodiment shown in FIG. 1C, each Conductor Disk Assembly 101b has four Conductors 105b. The Conductor Disk Assembly 101b further has a central Conductor Shaft Hole 107b. The Conductor Shaft Hole 107b is larger than the Magnet Shaft Hole 107a. A side view of the Conductor Disk Assembly 101b is shown in FIG. 1D wherein can be seen the same Disk Body 103, at least one Conductor 105b and Conductor Hole 107b. In one embodiment, the Disk Body 103 of a Conductor Disk Assembly 101b is made of electrically insulating material.

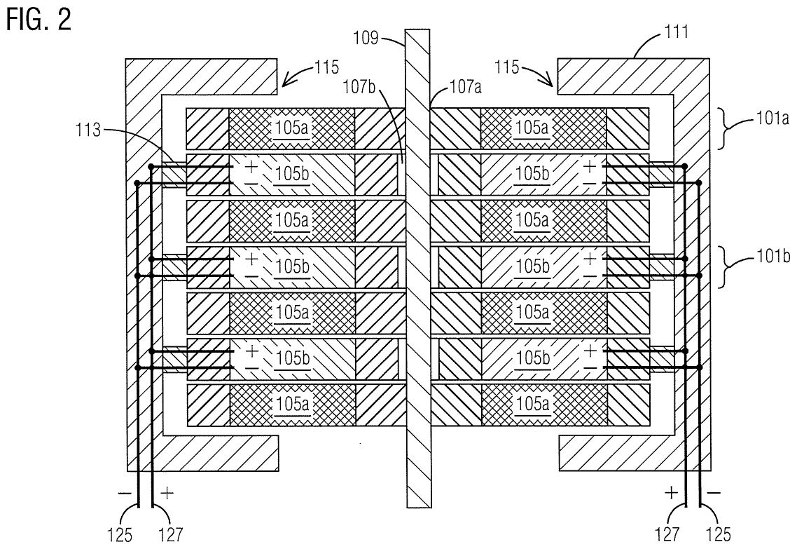

FIG. 2 is a cross sectional side view of a generator embodying the instant invention having a plurality of Magnet Disk Assemblies 101a and Conductor Disk Assemblies 101b. As shown in FIG. 2, each Magnet Disk Assembly 101a rotates about a central axis while each Conductor Disk Assembly 101b remains fixed and mounted to a Housing 111 by Housing Mounts 113. In one embodiment, the Housing 111 fully encloses each Magnet Disk Assembly 101a and each Conductor Disk Assembly 101b. A Drive Shaft 109 is passed through each Magnet Disk Assembly 101a (through the Magnet Shaft Hole 107a) and Conductor Disk Assembly 101b (through the Conductor Shaft Hole 107b). The Drive Shaft 109 is dimensionally sized to mate with each Magnet Shaft Hole 107a but to freely rotate within the larger Conductor Shaft Hole 107b. Additional connection means may be used as-needed to ensure that each Magnet Disk Assembly 101a is firmly mounted on the Drive Shaft 109. Each Magnet Disk Assembly 101a has at least one Magnet 105a. In the embodiment shown in FIG. 2, each Magnet Disk Assembly 101a has four Magnets 105a (only two of which are shown in the cross-sectional view depicted in FIG. 2) each of which are permanent magnets. Each Conductor Disk Assembly 101b has at least one Conductor 105b. In the embodiment shown in FIG. 2, each Conductor Disk Assembly 101b has four Conductors 105b (only two of which are shown in the cross-sectional view depicted in FIG. 2). A Positive Conductor Terminal 119 and a Negative Conductor Terminal 121 are electrically connected to each Conductor 105b. Each Positive Conductor Terminal 119 is then electrically connected to a Positive Conductor Bus 125 while each Negative Conductor Terminal 121 is electrically connected to a Negative Conductor Bus 127. Each Magnet Disk Assembly 101a and Conductor Disk Assembly 101b are spaced apart such that it is possible for each Magnet Disk Assembly 101a to spin without coming into contact with a neighboring Conductor Disk Assembly 101b.

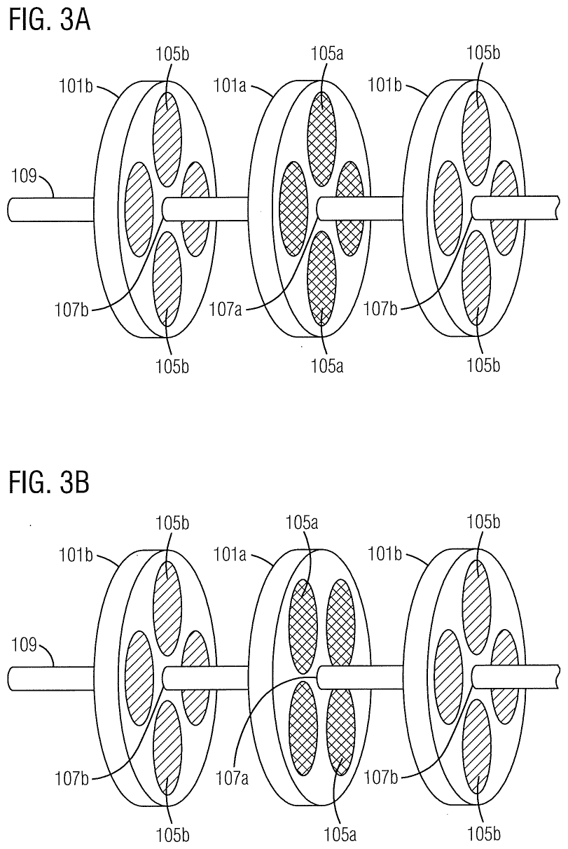

As a torque is applied to the Drive Shaft 109 by a prime mover, the Drive Shaft 109 rotates; causing each Magnet Disk Assembly 101a to rotate about an axis defined by the Drive Shaft 109. As the Magnet Disk Assembly 101a rotates, the rotating Magnets 105a create a rotating magnetic field with respect to each stationary Conductor Disk Assembly 101b (and, thus, to each stationary Conductor 105b). This rotating magnetic field variously intersects the Conductors 105b. Thus, under Faraday's law, an electric current is induced in the Conductors 105b. This electric current is drawn from the Conductors 105b from the Positive Conductor Terminal 119 and the Negative Conductor Terminal 121 which, in turn, are connected to the Positive Conductor Bus 125 and the Negative Conductor Bus 127. This process is illustrated in FIGS. 3A and 3B. More specifically, FIG. 3A depicts a first position wherein the Magnets 105a and the Conductors 105b are aligned. FIG. 3B depicts a second position wherein the Magnets 105a have rotated approximately 45 degrees with respect to the neighboring Conductors 105b.

In the embodiment shown in FIG. 2, there are a plurality of Magnet Disk Assemblies 101a and Conductor Disk Assemblies 101b. More specifically, the Magnet Disk Assemblies 101a and the Conductor Disk Assemblies 101b are arranged in alternating “layers,” i.e., the first layer is a Magnet Disk Assemblies 101a, the second layer is a Conductor Disk Assemblies 101b, the third layer is a Magnet Disk Assemblies 101a, and so on. In the embodiment shown in FIG. 2, the collection of these “layers” begins and ends with a Magnet Disk Assemblies 101a. This is important since it allows the first and last Conductor Disk Assemblies 101b to have a more uniform rotating magnetic field passing through each corresponding Conductor 105b, i.e., the looped conductive coil.

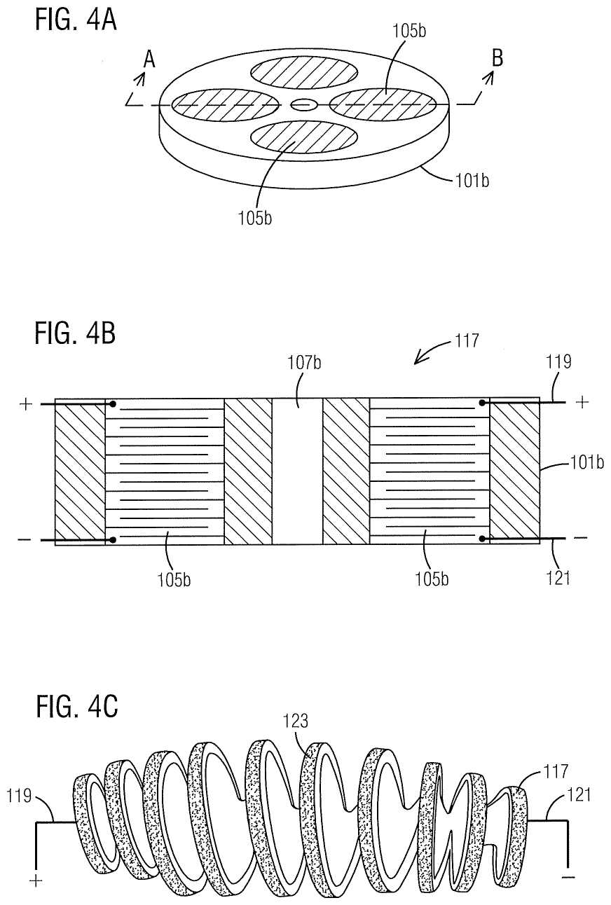

FIG. 4A is side perspective view of the Conductor Disk Assembly 101b shown in FIGS. 1C and 1D. In FIG. 4A, a line A̅B̅ is shown which bisects the Conductor Disk Assembly 101b and two of the Conductors 105b. A Positive Conductor Terminal 119 (not shown) and a Negative Conductor Terminal 121 (not shown) are connected to each Conductor 105b.

FIG. 4B is a cross-sectional view of a Conductor Disk Assembly 101b along a plane defined parallel to the conductor disk assembly along line A̅B̅ shown in FIG. 4A. The Conductor Disk Assembly 101b has a Magnet Shaft Hole 107a. In the embodiment shown in FIG. 4B, each Conductor 105b is comprised of a Helical Conductor Segment 117. This Helical Conductor Segment 117 is a continuous strip of helically-shaped conductive material such as copper, aluminum or other metals. The Helical Conductor Segment 117 has a first end and a distal second end. The first end of the Helical Conductor Segment 117 is connected to a Positive Conductor Terminal 119 while the second end of the Helical Conductor Segment 117 is connected to a Negative Conductor Terminal 121.

FIG. 4C is a rotated, exploded view of a Helical Conductor Segment 117. As can be seen in FIG. 4C, the Helical Conductor Segment 117 has a shape known as a “helicoid.” The entire exterior surface of the Helical Conductor Segment 117 has an Insulating Coating 123 which prevents an electrical connection from being made between any of the adjacent rings of the Helical Conductor Segment 117. In other words, the Helical Conductor Segment 117 has an effective electrical resistance corresponding to its full “length”—even when the Helical Conductor Segment 117 is compressed into a cylindrical-like shape. The Helical Conductor Segment 117 has a first end and a distal second end. The first end of the Helical Conductor Segment 117 is connected to a Positive Conductor Terminal 119 while the second end of the Helical Conductor Segment 117 is connected to a Negative Conductor Terminal 121.

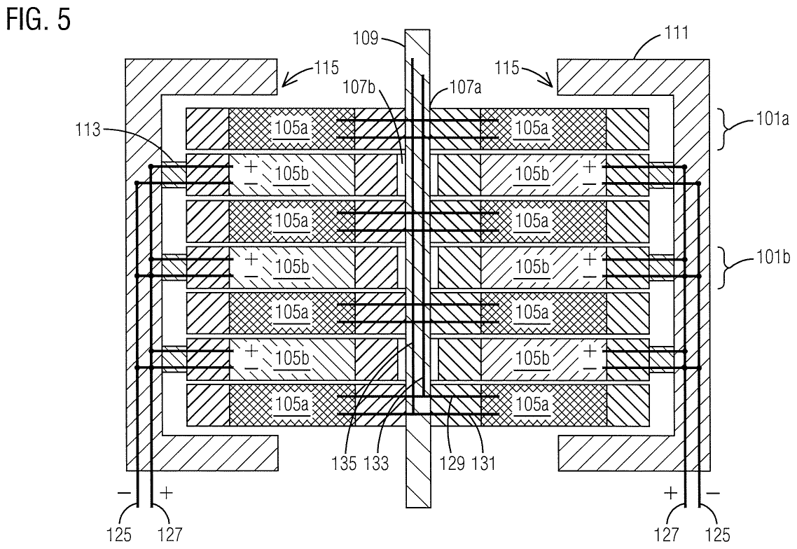

FIG. 5 is a cross sectional side view of a generator embodying the instant invention having a plurality of Magnet Disk Assemblies 101a and Conductor Disk Assemblies 101b in the same general configuration as shown in FIG. 2. That being said, whereas the embodiment shown in FIG. 2 depicted the use of permanent magnets, FIG. 5 shows the use of electromagnets. More specifically, the embodiment shown in FIG. 5 depicts a Magnet Disk Assembly 101a having four Magnets 105a which are electromagnets. Each Magnet 105a has a Positive Electromagnet Terminal 129 and a Negative Electromagnet Terminal 131 which, in turn, are electrically connected to a Positive Shaft Bus 133 and a Negative Shaft Bus 135, respectively. The Positive Shaft Buss 133 and Negative Shaft Bus 135 can be connected to a DC power source by means of brushes and slip rings or some other commonly understood methodology.

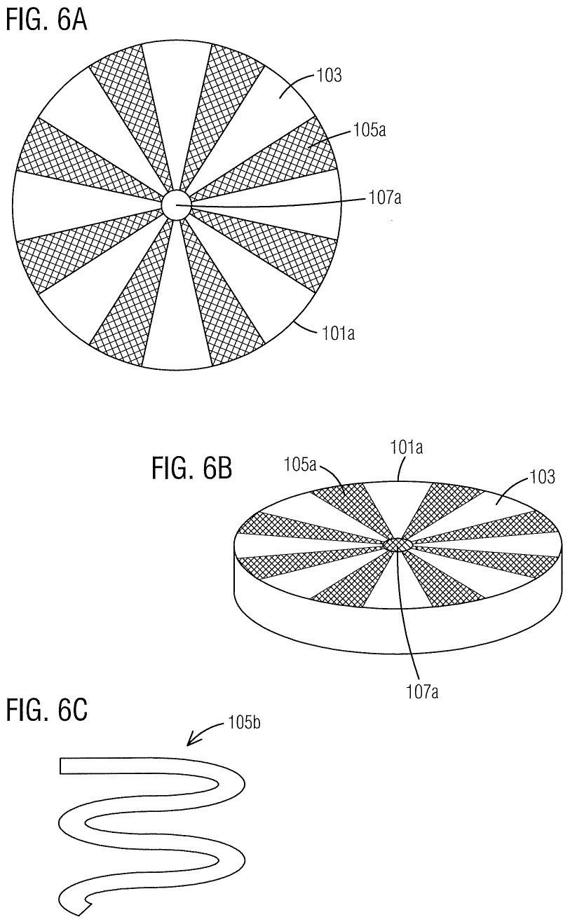

FIG. 6A is a top view of an alternative embodiment of a Magnet Disk Assembly 101a having a Disk Body 103 and at least one Magnet 105a. The at least one Magnet 105a has the shape of a circular sector (i.e., the portion of a disk enclosed by two radii and an arc). In this manner, any number of Magnets 105a can be evenly distributed across the Magnet Disk Assembly 101a. A side view of this same Magnet Disk Assembly 101a is shown in FIG. 6B. Similarly, a Conductor Disk Assembly 101b (not shown) can be made in this same manner—with each Conductor 105b formed in the shape of a circular sector. An example sketch of such a circular sector-shaped conductor segment (labeled as a Conductor 105b) may be found in FIG. 6C.

In the embodiment shown in FIGS. 1A through 2: (a) each Magnet Disk Assembly 101a has four Magnets 105a; and (b) each Conductor Disk Assembly 101b has four Conductors 105b. Thus, as two neighboring Magnet Disk Assemblies 101a rotate with respect to a Conductor Disk Assembly 101b in-between them, currents of identical phase, frequency and amplitude will be induced in each of the Conductors 105b. Thus, a unipolar alternating current will be generated. By varying the ratio of Magnets 105a to Conductors 105b, a generator with any desired number of poles can be created. For example, by having one Magnet 105a for every two Conductors 105b (e.g., two equally spaced Magnets 105a on each Magnet Disk Assembly 101a and four equally spaced Conductors 105b on each Conductor Disk Assembly 101b) a two-pole generator can be created (where each Conductor Terminal 119 and 121 from Conductors 105b located 180 degrees apart from one another are electrically connected). As another example, by having one Magnet 105a for every three Conductors 105b (e.g., two equally spaced Magnets 105a on each Magnet Disk Assembly 101a and six equally spaced Conductors 105b on each Conductor Disk Assembly 101b) a three-pole generator can be created.

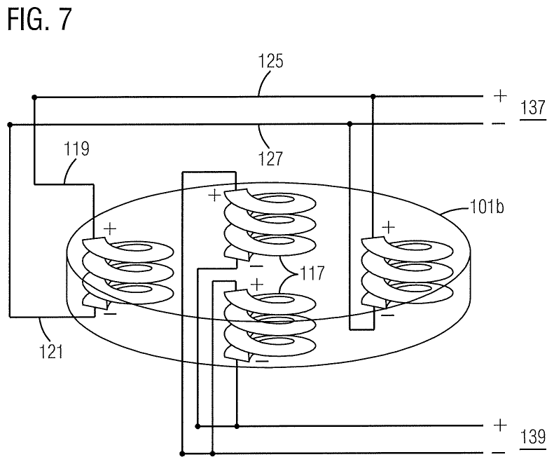

The example of a two-pole system is shown in FIG. 7, which depicts a wiring diagram for same. As can be seen in FIG. 7, the Conductor Disk Assembly 101b has four Conductors 105b each of which are comprised of a Helical Conductor Segment 117. Each of the Helical Conductor Segments 117 are connected to a Positive Conductor Terminal 119 and a Negative Conductors Terminal 121. The Positive Conductor Terminals 119 corresponding to oppositely spaced Conductors 105b are connected to a common Positive Conductor Bus 125 while the Negative Conductor Terminals 121 corresponding to oppositely spaced Conductors 105b are connected to a common Negative Conductor Bus 127. In the two phase system shown in FIG. 7, a first Positive Conductor Bus 125 and Negative Conductor Bus 127 has an induced current of Output One 127 while a second Positive Conductor Bus 125 and Negative Conductor Bus 127 has an induced current of Output Two 139.

It is to be understood that while a preferred embodiment of the invention is illustrated, it is not to be limited to the specific form or arrangement of parts herein described and shown. It was be apparent to those skilled in the art that various changes may be made without departing from the scope of the invention and the invention is not to be considered limited to what is shown and described in the specification and drawings.

I claim:

1. An induction generator comprising:
(i) at least one rotatable magnet disk assembly having:
(a) at least one magnet; and
(b) a magnet shaft hole;
(ii) at least one stationary conductor disk assembly having:
(a) at least one conductor comprising a loop of conducting material; and
(b) a conductor shaft hole dimensionally sized to be larger than the magnet shaft hole;
(iii) a drive shaft dimensionally sized to mate with the magnet shaft hole;
(iv) a positive conductor terminal and a negative conductor terminal electrically connected to the at least one conductor; and
(v) an exterior housing which encloses the at least one magnet disk assembly and the at least one conductor disk assembly, said conductor disk assemblies mounted to the housing.

2. The induction generator of claim 1 wherein:
the conductor is a helical conductor segment.

3. The induction generator of claim 1 wherein:
the at least one magnet is an electromagnet; and
the electromagnet is powered by a direct current generator which is connected to the drive shaft.

4. The induction generator of claim 2 wherein:
the at least one magnet is an electromagnet; and
the electromagnet is powered by a direct current generator which is connected to the drive shaft.

5. The induction generator of claim 4 wherein:
there are a plurality of magnet disk assemblies and conductor disk assemblies; and
the magnet disk assemblies and conductor disk assemblies are arranged in alternating layers, said layers beginning and ending with a magnet disk assembly;

6. The induction generator of claim 5 wherein:
each positive conductor terminal is connected to a positive conductor bus;
each negative conductor terminal is connected to a negative conductor bus; and
alternating current power is drawn from the positive and negative conductor busses.

7. The induction generator of claim 5 wherein:
there are an even number of conductors spaced equidistant from one another;
the positive conductor terminal for each pair of conductors located 180 degrees apart is connected to a positive conductor bus;
the negative conductor terminal for each pair of conductors located 180 degrees apart is connected to negative conductor bus; and
alternating current power is drawn from the positive and negative conductor busses.

8. The induction generator of claim 7 wherein:
the conductors and magnets are configured to produce three-phase AC power.

9. The induction generator of claim 1 wherein:
the conductor is a circular sector-shaped conductor segment; and
the magnet is a circular sector-shaped conductor segment.

10. The induction generator of claim 1 wherein:
a rectifier is added to the positive conductor terminal and the negative conductor terminal to produce direct current power.
